(19) United States
(12) Patent Application Publication
(10) Pub. No.: US 2013/0201304 A1
(43) Pub. Date: Aug. 8, 2013

(54) System for Displaying Stereoscopic Images

(71) Applicant: LEICA MICROSYSTEMS (SCHWEIZ) AG, Heerburgg (CH)

(72) Inventor: Ulrich Sander, Rebstein (CH)

(73) Assignee: LEICA MICROSYSTEMS (SCHWEIZ) AG, Heerburgg (CH)

(21) Appl. No.: 13/752,608

(22) Filed: Jan. 29, 2013

(30) Foreign Application Priority Data
Feb. 2, 2012 (DE) 10 2012 201 564.7

(51) Int. Cl. H04N 13/02

(52) U.S. Cl. CPC H04N 13/026
USPC 348/51

(57) ABSTRACT

The present invention relates to a system for displaying stereoscopic microscope images, including a display screen (130) and a computer device (120) for computing or providing stereoscopic images from monoscopic images. The computer device (120) has an evaluator configured to evaluate the stereoscopic perceptibility of the computed or provided stereoscopic images and, in case that it is determined that at least one region of a stereoscopic image cannot be stereoscopically perceived, for replacing the computed or provided stereoscopic image with a monoscopic image in this region.

### CROSS REFERENCE TO RELATED APPLICATIONS

This application claims priority of German patent application number 10 2012 201 564.7 filed Feb. 2, 2012, the entire disclosure of which is incorporated by reference herein.

### FIELD OF THE INVENTION

The present invention relates to a system for displaying stereoscopic images.

### BACKGROUND OF THE INVENTION

Display of stereoscopic microscope images on display screens is becoming more and more important and is now desired by users for many applications. Widespread today are systems that have display screens for stereoscopic display which require the use of active or passive glasses for viewing. As an example, reference is made here to the “TrueVision” system of the TrueVision 3D Surgical company.

More recent developments already have display screens for which no glasses are needed.

Conventional systems for displaying stereoscopic microscope images have the significant drawback that they evaluate or set the stereopsis incorrectly. “Stereopsis” is understood to mean the ability to obtain depth information from monoscopic image pairs that are stereoscopically correlated. Such image pairs show the same object or the same motif from slightly different viewing angles. As a result, the position, the orientation, or also the shading of objects and surfaces differ in the two monoscopic images, and an impression of depth that is required for stereoscopic vision can be obtained from these differences.

Closely associated with stereopsis is what is known as parallax. The term “parallax” refers to the apparent change in the position of an observed object produced by a shift in the position of the observer; i.e., a change in the viewing angle. Thus, stereoscopic depth perception is based on the parallax-related differences between the monoscopic images of the two eyes. As mentioned, the term “monoscopic image” is understood to mean the individual image of an observed scene, as seen by each eye. The arithmetic combination or fusion of two such images through corresponding brain activities of an observer leads to stereoscopic depth perception; i.e., three-dimensional perception.

Thus, stereopsis and parallax constitute criteria for the evaluation of a stereoscopic perceptibility of stereoscopic image pairs.

Incorrect stereopsis adjustment and/or excessive parallax results in that stereo image pairs displayed on a display screen can no longer be fused by the observer. As a consequence, in practice, such display systems are not accepted by users because they deliver incompatible or useless visual impressions. Such false visual impressions are produced, for example, when narrow channels are used in connection with the displaying of microscopically captured images on a display screen (monitor). Here, the right and left (monoscopic) images can no longer be fused together because they are spaced apart too much on the display screen.

It is an object of the present invention to provide a system for displaying stereoscopic microscope images which will overcome, to the extent possible, the incompatibilities described above.

### SUMMARY OF THE INVENTION

This object is achieved by a system for displaying stereoscopic microscope images having the features described herein.

It is a feature of the present invention that it determines for all or at least several stereoscopic image pairs of a stereoscopic image if these are stereoscopically perceptible to an observer. If this is not the case, a monoscopic image (e.g., the right or the left monoscopic image) is displayed on the display screen in place of the image pairs that are not stereoscopically resolvable or perceptible.

Thus, overall, a scene or an image may be displayed on a display screen in a representation that is partly stereoscopic and partly monoscopic. It has been found that such a combination of stereoscopic and monoscopic partial images does not result in any incompatible or disagreeable visual impressions.

Preferred embodiments of the present invention are the subject matter of the dependent claims.

In a particularly preferred embodiment of the present invention, it is determined whether or not the parallax of provided or calculated stereoscopic images exceeds a threshold that is associatable with the stereoscopic perceptibility. Then, a monoscopic image can be made generated and/or made available in the regions or for the image pairs that exceed this threshold, and a stereoscopic image can be generated and made available in the regions where this threshold is not exceeded. These two conditions can be superimposed on one another so that a mixed stereoscopic and monoscopic image is generated for an observer. For example, if the monoscopically displayed image regions are very small compared to the stereoscopically displayed image regions, the superimposition of monoscopic and stereoscopic image regions is hardly perceptible to an observer. Overall, the image appears substantially as a stereoscopic image.

It is preferred that the evaluation means be capable of replacing a stereoscopic image with one of the monoscopic images; i.e., for example, with the left or the right image, or with a composite monoscopic image computed from the two images. Such a composite monoscopic image may, for example, be a monoscopic image whose position is between the positions of the respective right and left monoscopic images.

Further advantages and embodiments of the present invention will become apparent from the description and the accompanying drawings.

It will be understood that the aforementioned features and those described below can be used not only in the specified combinations, but also in other combinations or alone without departing from the scope of the present invention.

The present invention is schematically illustrated in the drawings using an exemplary embodiment, and will be described below in detail with reference to the drawings.

### BRIEF DESCRIPTION OF THE DRAWINGS

In the drawings:

FIG. 1 shows a schematic representation of the essential components of a preferred embodiment of a system according to the present invention; and

FIGS. 2a through 2c show a schematic representation of a display screen showing two monoscopic images of a displayed motive, and, also schematically, the images that may be produced for an observer.

### DETAILED DESCRIPTION OF THE INVENTION

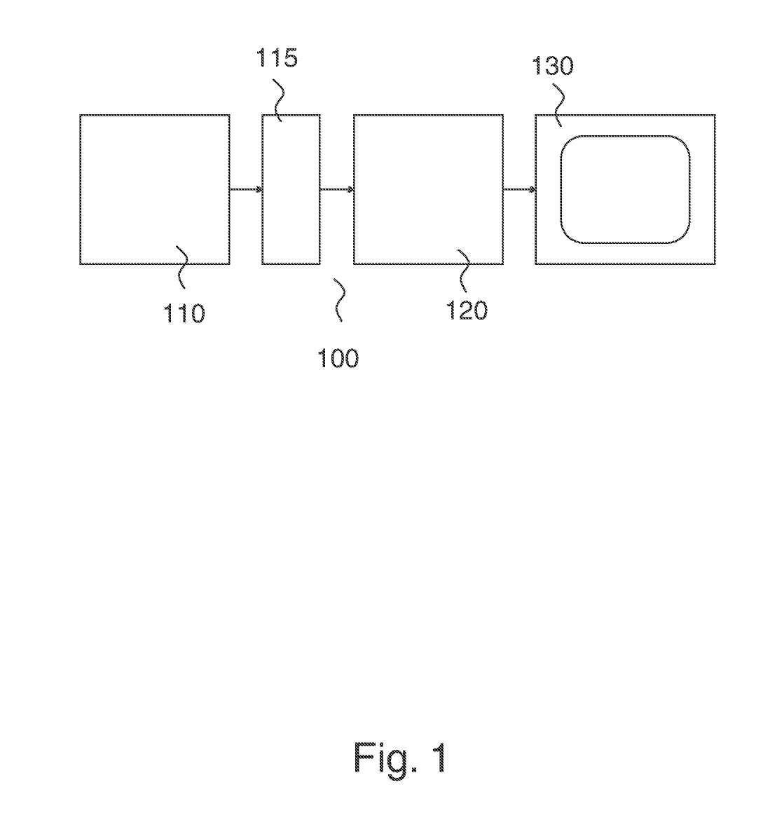

In FIG. 1, a preferred embodiment of the system according to the present invention is shown in purely schematic form and designated 100. System 100 includes a stereomicroscope 110 for stereoscopically viewing an object to be observed. Stereomicroscope 110 may be provided with eyepieces (not shown) for direct stereoscopic viewing of the object. The basic design of a stereomicroscope is known to those skilled in the art, and therefore does not need to be described in detail herein. Examples that may be mentioned include the stereomicroscopes described in Patent Publications DE 102 55 961 A1, DE 103 32 603 A1, DE 10 2004 022 330 A1 and DE 10 2010 003 640 A1.

Stereomicroscope 110 is connected to a recording device 115 having, for example, a CCD chip for each stereoscopic viewing channel (not shown). Not shown is an output coupling device, such as a semitransparent mirror, which may be used in this connection.

The aforesaid CCD chips are used to record respective images; i.e., a left and a right monoscopic image, of an object being observed. The CCD chips (also not shown) of recording device 115 are connected to a computer device 120. Computer device 120 is capable of computing or generating a stereoscopically perceptible image based on the images recorded by the respective CCD chips. Computer device 120 is designed, for example, to apply an algorithm to the two images and/or to a composite or computed stereoscopic image, which algorithm measures the distances between stereo image pairs and suppresses one of the two monoscopic images when a predetermined threshold is exceeded. This stereoscopic image is displayable on a display screen 130 connected to computer device 120. As for the stereoscopically perceptible images, reference may be made, for example, to monoscopic images which are displayed on the display screen in rapid alternation. Each image should be displayed about 60 times per second, which results in a total of 120 individual images per second. In order for such alternatingly displayed images to be perceived stereoscopically, typically so-called shutter glasses are required which are able to filter out the correct half-images for each eye. If the intension is not to use glasses, another option is to simultaneously display the two images in an interleaved line pattern. A correspondingly patterned film provided on or in front of the display screen can then filter out the two images and display them at a specific angle with respect to each other, thereby enabling stereoscopic observation. Finally, reference is made to the so-called eye-tracking method, in which the eye orientation of a viewer is determined and used.

It is a feature of the present invention that computer device 120 determines for several or all regions of the computed stereoscopic image whether or not the parallax between the two monoscopic images exceeds a presettable or selectable threshold for this region. For regions in which this parallax does not exceed the threshold, the stereoscopic image is provided to display screen 130. However, for regions in which the parallax reaches or exceeds the threshold, the initially provided stereoscopic image is replaced with a monoscopic image, i.e., for example, with the left or the right (monoscopic) image, and the respective monoscopic image is displayed on display screen 130 for this region. Thus, overall, a composite stereoscopic and monoscopic image may be produced on display screen 130, without this image being disagreeable to the observer.

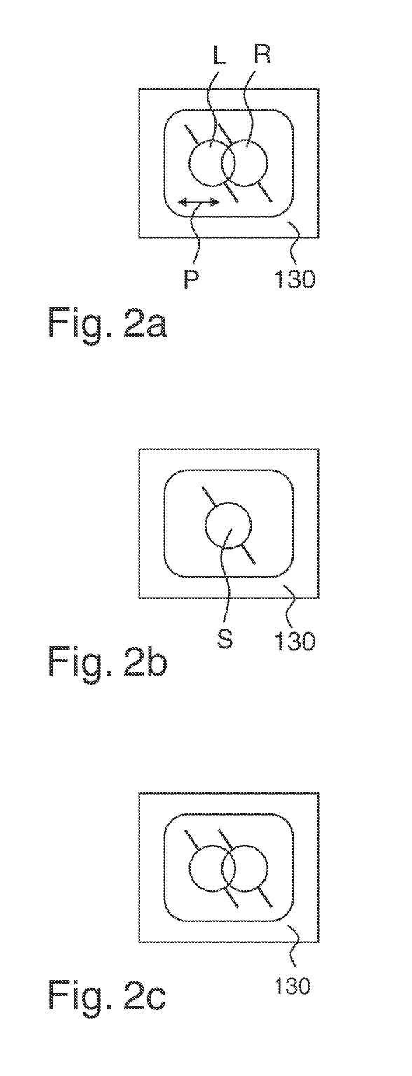

This relationship will be explained again with reference to FIGS. 2a through 2c: In FIG. 2a, by way of example, the left monoscopic image L and the right monoscopic image R of an object or a corresponding region being observed are displayed on display screen 130. As described above, there are various ways to implement such superimposed images in practice. The parallax is given, for example, by the distance P between the two centers of the images. If this parallax is smaller than a certain threshold, which is determinable for a population of users or also for individual users, then an observer is able to process the two images in such a way that they appear as a stereoscopic image. This condition is shown in FIG. 2B. In contrast, if parallax P is greater than this threshold, then the observer is no longer able to fuse these two images. The observer will see a double image which appears blurred, as shown by way of example in FIG. 2C, where the monoscopic images L, R cannot be fused.

### PARTS LIST

100 system

110 stereomicroscope

115 recording device

120 computer device

130 display screen

P parallax

L left monoscopic image

R right monoscopic image

S stereoscopic image

What is claimed is:

1. A system for displaying stereoscopic microscope images, comprising:
a display screen (130); and
a computer device (120) configured to compute or provide a stereoscopic image from monoscopic images, the computer device (120) including an evaluator configured to evaluate stereoscopic perceptibility of the computed or provided stereoscopic image;
wherein the evaluator is configured to replace at least one region of the computed or provided stereoscopic image with a replacement monoscopic image if the evaluator determines that the at least one region of the computed or provided stereoscopic image cannot be stereoscopically perceived.

2. The system of claim 1, wherein the evaluator is configured to determine whether a parallax of the computed or provided stereoscopic image exceeds a threshold that is associated with stereoscopic perceptibility.

3. The system of claim 1, wherein the evaluator is configured to replace the stereoscopic image with one of the monoscopic images or with a composite monoscopic image computed from the monoscopic images.

4. A method for displaying stereoscopic microscope images on a display screen (130), comprising:
computing or providing a stereoscopic image with a computer device (120) based on monoscopic images;
evaluating stereoscopic perceptibility of the computed or provided stereoscopic image by the computer device (120);
determining whether at least one region of the computed or provided stereoscopic image cannot be stereoscopically perceived; and
replacing the at least one region of the computed or provided stereoscopic image with a replacement monoscopic image.

5. The method of claim 4, wherein determining whether the at least one region of the computed or provided stereoscopic image cannot be stereoscopically perceived includes determining whether a parallax of the computed or provided stereoscopic image exceeds a threshold that is associated with stereoscopic perceptibility.

6. The method of claim 4, wherein the replacement monoscopic image is one of the monoscopic images or a composite monoscopic image computed from the monoscopic images.
